(19) United States
(12) Patent Application Publication
(10) Pub. No.: US 2026/0101291 A1
(43) Pub. Date: Apr. 9, 2026

(54) REPORTING POWER CLASS CHANGE BY POWER HEADROOM REPORT (PHR)

(71) Applicant: Telefonaktiebolaget LM Ericsson (publ), Stockholm (SE)

(72) Inventors: Maomao CHEN LARSSON, Lund (SE); Christian BERGLJUNG, Lund (SE); Robert Mark HARRISON, Grapevine, TX (US); Peter ALRIKSSON, Hörby (SE)

(21) Appl. No.: 19/115,428

(22) PCT Filed: Sep. 29, 2023
(86) PCT No.: PCT/EP2023/077094

§ 371 Date: Mar. 26, 2025

Related U.S. Application Data
(60) Provisional application No. 63/412,249, filed on Sep. 30, 2022.

(51) Int. Cl. H04W 52/36; H04L 5/00

(52) U.S. Cl. CPC H04W 52/365; H04L 5/0098

(57) ABSTRACT

A method and wireless device (WD) are disclosed. According to some embodiments, a network node configured to communicate with a wireless device is provided. According to one aspect, a method in a WD includes triggering a first power headroom report (PHR) when a prohibit timer has expired and at least one power class fallback value exceeds a threshold. The method also includes transmitting the first PHR.

### TECHNICAL FIELD

The present disclosure relates to wireless communications, and in particular, to a reporting of a power class modification.

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)) and Sixth Generation (6G) wireless communication systems. Such systems provide, among other features, broadband communication between network nodes, such as base stations, and mobile wireless devices (WD), as well as communication between network nodes and between WDs.

The technical background is described for the 5G NR standard with references to the 4G LTE standard but can apply to any system with similar uplink power reporting events. Throughout, the term network node may refer to a central node and wireless device for a device connected to the network node.

For 4G and 5G the power reporting is referred to as a power-headroom report (PHR) that is governed by the power capability and uplink power control.

### Power Control and Power Capability

Power capability determines the maximum wireless device uplink power per cell or for CA (e.g., carrier aggregation). The uplink power remaining given a transmission allocation by the network node is also reported to the network node (by power headroom reporting).

The wireless device output power for uplink transmissions (wireless device to network node) is controlled independently for each cell c and carrier frequency f. The power control for uplink transmissions in a transmission occasion i typically involve both open- and closed-loop control:

$${P}_{f , c} ( i ) = min [ {P}_{CMAX , f , c} ( i ) , {P}_{0} + {α}_{f , c} {PL}_{f , c} + 10 log {M}_{f , c} ( i ) + {Δ}_{f , c} ( i ) + {δ}_{f , c} ( i ) ]$$

where P₀ is the target received power at the receiver (of the network node for NR), PL_{ƒ,c} the path-loss estimate with a weight factor α_{c,ƒ} (the sum P₀+α_{ƒ,c}PL_{ƒ,c} the transmission resources required output power per resource for open-loop control), M_{ƒ,c} the allocated resource bandwidth, Δ_{ƒ,c} including factors such as the uplink modulation format and δ_{ƒ,c} a relative power change for closed-loop control.

The output power as determined by open- and closed loop power control is limited by the maximum output power P_{CMAX,ƒ,c}(i) configured (computed) by the wireless device for cell c and carrier frequency ƒ. The configured P_{CMAX,ƒ,c}(i) applies for all types of transmissions (physical uplink control channel (PUCCH), physical uplink shared channel (PUSCH) and sounding reference signal (SRS)) and is in turn capped by the power capability P_{power class}. For NR in frequency range FR1 below 7 GHz for which the output power can be measured at the antenna connector, the P_{CMAX,ƒ,c}(i) configured can essentially be described by:

$${P}_{CMAX , f , c} ( i ) ∼ min [ {P}_{power class} , f ( {P}_{power class} , MPR ) , {P}_{Max} ]$$

and hence limited by:
the power capability P_{power class} of the wireless device, indicated to the network node by wireless device capability signaling;
a function ƒ(P_{power class}, MPR)≤P_{power class} of the power capability and maximum power reductions MPR allowed for compliance with, e.g., unwanted emissions requirements; and
a cell-specific or wireless device-specific limitation P_{Max} (absolute) indicated to the wireless device by the network node in the system information broadcasted in the cell or by dedicated signaling to the wireless device.

The wireless device is allowed a power-back-off up to MPR (dB) but does not necessarily use the full allowance. The P_{CMAX,ƒ,c}(i) is therefore specified in a range, from 3GPP standards such as from, for example, 3GPP Technical Specification (TS) 38.101-1 v17.6.0 2022-06 for a single serving cell in FR1,

The configured maximum output power P_{CMAX,ƒ,c} is set within the following bounds:

$${P}_{CMAX \_ L , f , c} \leq {P}_{CMAX , f , c} \leq {P}_{CMAX \_ H , f , c} with$$

$${P}_{CMAX \_ L , f , c} = MIN \{ {P}_{EMAX , c} - Δ {T}_{C , c} , ( {P}_{P owerClass} - Δ {P}_{P owerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \}$$

$${P}_{CMAX \_ H , f , c} = \{ {P}_{EMAX , c} , {P}_{PowerClass} - Δ {P}_{PowerClass} \}$$

where the lower bound is governed by the maximum allowed back-off MPR (maximum power reduction) while both the upper and lower bounds are limited by the power class (power capability) P_{power class} and a cell-specific limit class P_{Max} (the P_{EMAX,c}). Other allowed power reductions accounting for, e.g., filter attenuation (ΔT_{C}), also reduce the lower bound at the edges of carriers but are not included in what follows for notational simplicity without loss of generality. The upper bound corresponds to the case in which the wireless device is not applying any power back-off and is limited by the power class and power limits only. The power class may be modified by ΔP_{powerclass} in case the maximum power capability must be reduced for, e.g., exposure compliance (SAR).

### Power-Class (Power Capability) Modification and Exposure Compliance

Power class/capability may be modified for compliance with maximum exposure (MPE) measured as a Specific Absorption Ratio (SAR) below 10 GHz and MPE (usually) measured as a power-flux density for higher frequencies. These limits are averaged in time and thus determined by both the power level and the uplink (UL) duty cycle. There are two different allowances. The power class in the power-control equations can be modified by ΔP_{power class} under specific conditions, e.g., when the uplink transmission duty cycle exceeds a threshold in time division duplex (TDD) bands (UL/DL configuration). The conditions are specified but not the event in time at which the ΔP_{power class} is applied. The other allowance is a proprietary power back-off denoted P-MPR (‘P’ for power management) the limits of which is not specified. This back-off is often used in case proximity sensors detect presence of a user and can be applies at any instance in time. Both allowances affect the UL power and thus, also affect the reporting of remaining uplink power in the power-headroom report. The power class can also be reduced due to internal wireless device heat management.

### Carrier Aggregation and Power Capability

Power capability is also reported for CA with more than one serving cell in the uplink.

For carrier aggregation (CA), the wireless device configures a maximum total power P_{CMAX} for all aggregated serving cells of a CA combination. For FR1, the P_{CMAX} is specified at the antenna connector and includes the power back-off applied on the serving cells part of the CA configuration; for inter-band UL CA the is essentially the sum of the configured power per cell and capped by the power class ΔP_{power class,CA} of the CA band combination.

The total configured maximum output power P_{CMAX} shall be set within the following bounds:

$${P}_{CMAX \_ L} \leq {P}_{CMAX} \leq {P}_{CMAX \_ H}$$

For uplink inter-band carrier aggregation with one serving cell c per operating band when same slot symbol pattern is used in all aggregated serving cells:

$${P}_{CMAX \_ L} = MIN \{ 10 {log}_{10} \sum MIN [ {p}_{EMAX , c} / ( Δ {t}_{C , c} ) , {p}_{PowerClass , c} / ( MAX ( {mpr}_{c} \cdot Δ {mpr}_{c} , a - {mpr}_{c} ) \cdot Δ {t}_{C , c} \cdot Δ {t}_{IB , c} \cdot Δ {t}_{RxSRS , c} ) , {p}_{PowerClass , c} / {pmpr}_{c} ] , {P}_{EMAX , CA} , {P}_{PowerClass , CA} - Δ {P}_{PowerClass , CA} \}$$

$${P}_{CMAX \_ H} = MIN \{ 10 {log}_{10} \sum {p}_{EMAX , c} , {P}_{EMAX , CA} , {P}_{PowerClass , CA} - Δ {P}_{PowerClass , CA}$$

$${P}_{CMAX \_ H} = MIN \{ 10 {log}_{10} \sum {p}_{EMAX , c} , {P}_{EMAX , CA} , {P}_{PowerClass , CA} - Δ {P}_{PowerClass , CA}$$

The configured total power P_{CMAX} for all aggregated serving cells of a CA combination is used for prioritizations of transmission power when the wireless device is power limited, from 3GPP standards such as from, for example, 3GPP TS 38.213 v17.3.0 2022-09,

### Prioritizations for Transmission Power Reductions

For single cell operation with two uplink carriers or for operation with carrier aggregation, if a total WD transmit power for PUSCH or PUCCH or PRACH or SRS transmissions on serving cells in a frequency range in a respective transmission occasion i would exceed \hat{P}_{CMAX}(i), where \hat{P}_{CMAX}(i) is the linear value of P_{CMAX} (i) in transmission occasion i as defined in 3GPP standards such as, for example, [8-1, 3GPP TS 38.101-1] for FR1 and [8-2, 3GPP TS 38.101-2] for FR2, the wireless device allocates power to PUSCH/PUCCH/PRACH/SRS transmissions according to the following priority order (in descending order) so that the total wireless device transmit power for transmissions on serving cells in the frequency range is smaller than or equal to \hat{P}_{CMAX}(i) for that frequency range in every symbol of transmission occasion i. When determining a total transmit power for serving cells in a frequency range in a symbol of transmission occasion i, the wireless device does not include power for transmissions starting after the symbol of transmission occasion i. The total wireless device transmit power in a symbol of a slot is defined as the sum of the linear values of wireless device transmit powers for PUSCH, PUCCH, PRACH, and SRS in the symbol of the slot.
PRACH transmission on the Pcell;
PUCCH or PUSCH transmissions with higher priority index according to Clause 9;
For PUCCH or PUSCH transmissions with same priority index:
   PUCCH transmission with HARQ-ACK information, and/or SR, and/or LRR, or PUSCH transmission with HARQ-ACK information;
   PUCCH transmission with CSI or PUSCH transmission with CSI;
   PUSCH transmission without HARQ-ACK information or CSI and, for Type-2 random access procedure, PUSCH transmission on the Pcell;
SRS transmission, with aperiodic SRS having higher priority than semi-persistent and/or periodic SRS, or PRACH transmission on a serving cell other than the PCell.

In case of same priority order and for operation with carrier aggregation, the wireless device prioritizes power allocation for transmissions on the primary cell of the master cell group (MCG) or the secondary cell group (SCG) over transmissions on a secondary cell. In case of same priority order and for operation with two UL carriers, the wireless device prioritizes power allocation for transmissions on the carrier where the wireless device is configured to transmit PUCCH. If PUCCH is not configured for any of the two UL carriers, the wireless device prioritizes power allocation for transmissions on the non-supplementary UL carrier.

Given a total power P_{CMAX}, the WD allocates power for transmission types in a priority order when power limited. This means that, e.g., that the primary cell (PCell) is prioritized for a given transmission, e.g., for simultaneous PUSCH transmissions on multiple serving cells.

The power class of the CA configuration can also be modified by a to account for MPE requirements by ΔP_{power class,CA} for concurrent uplink transmissions on more several uplink serving cells. This means that the wireless device would start prioritizing the uplink power at ΔP_{power class,CA} lower output power (dB scale). The conditions at which this is allowed is specified for selected cases and can depend on the uplink duty cycles on the serving cells. The power class for band combination (CA or dual-connectivity) may be different from the power-class for the constituent bands. In case the P_{power class,CA} possibly modified by ΔP_{power class,CA} for the band combination is lower than the P_{power class} for constituent band, transmission power on the latter would be prioritized (reduced).

### Power Headroom Reporting

The power capability determines the power headroom (PH) reported in the power-headroom report (PHR):

$$P H = {P}_{CMAX , f , c} ( i ) - [ {P}_{0} + {α}_{f , c} {PL}_{f , c} + 10 log {M}_{f , c} ( i ) + {Δ}_{f , c} ( i ) + {δ}_{f , c} ( i ) ]$$

the ratio/difference (linear/dB) between the configured maximum output power (depending on the power class):

$${P}_{CMAX , f , c} ( i ) ∼ min [ {P}_{power class} , f ( {P}_{power class} , MPR ) , {P}_{Max} ]$$

and the estimated output power required for the uplink transmission scheduled by the BS. A positive value (in dB) means that there is remaining power available while a negative PH means that the uplink power is capped by the maximum power and that there is a power deficiency for the uplink allocation. The maximum output power is also reported in the PHR.

In case the maximum power is modified by ΔP_{power class} or P-MPR (or any other power back-off included in the P_{CMAX,ƒ,c}) then the PH is changed for a given scheduled uplink transmission.

The PH can be based on an actual transmission with a scheduled uplink resource (M_{ƒ,c}(i) in the expression above) or a reference format without a scheduled resource and an assumption that all power back-off are set to zero (including P-MPR). The WD determines the PHR as follows in 3GPP standards such as in, for example, 3GPP TS 38.213 v17.3.0 2022-09, where it is specified that the WD determines whether a PH value for an activated Serving Cell is based on real transmission or a reference format. This is determined by considering the configured grant(s) or periodic/semi-persistent SRS transmissions and downlink control information which has been received until and including the PDCCH occasion in which the first UL grant for a new transmission is received since a PHR has been triggered if the PHR MAC CE is reported on an uplink grant received on the PDCCH or until the first uplink symbol of PUSCH transmission minus PUSCH preparation time as defined in 3GPP standards such as in, for example, subclause 3GPP TS 38.214 if the PHR MAC CE is reported on a configured grant.

The ΔP_{powerclass} affects the PHR for both an actual transmission and the reference format for both PUSCH and SRS. The application of ΔP_{powerclass} in time is up to wireless device implementation.

According to 3GPP standards such as, for example, 3GPP TS 38.321 v17.1.0 2022-06, PHR is described as below.
[the description starts here]

### Power Headroom Reporting

The Power Headroom reporting procedure is used to provide the serving network node with the following information:
Type 1 power headroom: the difference between the nominal wireless device maximum transmits power and the estimated power for UL-SCH transmission per activated Serving Cell;
Type 2 power headroom: the difference between the nominal wireless device maximum transmit power and the estimated power for UL-SCH and PUCCH transmission on SpCell of the other MAC entity (i.e., E-UTRA MAC entity in EN-DC, NE-DC, and NGEN-DC cases);
Type 3 power headroom: the difference between the nominal wireless device maximum transmit power and the estimated power for SRS transmission per activated Serving Cell;
   MPE P-MPR: the power backoff to meet the MPE FR2 requirements for a Serving Cell operating on FR2.
      RRC controls Power Headroom reporting by configuring the following parameters:
phr-Periodic Timer;
phr-ProhibitTimer;
phr-Tx-PowerFactorChange;
phr-Type2OtherCell;
phr-Mode OtherCG;
multiplePHR;
mpe-Reporting-FR2;
mpe-ProhibitTimer;
mpe-Threshold;
numberOfN;
mpe-ResourcePool;
twoPHRMode.
   A Power Headroom Report (PHR) is triggered if any of the following events occur:
phr-ProhibitTimer expires or has expired and the path loss has changed more than phr-Tx-PowerFactorChange dB for at least one RS used as pathloss reference for one activated Serving Cell of any MAC entity of which the active DL BWP is not dormant BWP since the last transmission of a PHR in this MAC entity when the MAC entity has UL resources for new transmission;
NOTE 1: The path loss variation for one cell assessed above is between the pathloss measured at present time on the current pathloss reference and the pathloss measured at the transmission time of the last transmission of PHR on the pathloss reference in use at that time, irrespective of whether the pathloss reference has changed in between. The current pathloss reference for this purpose does not include any pathloss reference configured using pathlossReferenceRS-Pos in 3GPP TS 38.331.
phr-PeriodicTimer expires;
upon configuration or reconfiguration of the power headroom reporting functionality by upper layers, which is not used to disable the function;
activation of an SCell of any MAC entity with configured uplink of which first Active DownlinkBWP-Id is not set to dormant BWP;
activation of an SCG;
addition of the PSCell except if the SCG is deactivated (i.e., PSCell is newly added or changed);
phr-ProhibitTimer expires or has expired, when the MAC entity has UL resources for new transmission, and the following is true for any of the activated Serving Cells of any MAC entity with configured uplink:
   there are UL resources allocated for transmission or there is a PUCCH transmission on this cell, and the required power backoff due to power management (as allowed by P-MPR_{c} as specified in 3GPP TS 38.101-1, 3GPP TS 38.101-2, and 3GPP TS 38.101-3) for this cell has changed more than phr-Tx-PowerFactorChange dB since the last transmission of a PHR when the MAC entity had UL resources allocated for transmission or PUCCH transmission on this cell;
Upon switching of activated BWP from dormant BWP to non-dormant DL BWP of an SCell of any MAC entity with configured uplink;
if mpe-Reporting-FR2 is configured, and mpe-ProhibitTimer is not running:
   the measured P-MPR applied to meet FR2 MPE requirements as specified in 3GPP TS 38.101-2 is equal to or larger than mpe-Threshold for at least one activated FR2 Serving Cell since the last transmission of a PHR in this MAC entity; or
   the measured P-MPR applied to meet FR2 MPE requirements as specified in 3GPP TS 38.101-2 has changed more than phr-Tx-PowerFactorChange dB for at least one activated FR2 Serving Cell since the last transmission of a PHR due to the measured P-MPR applied to meet MPE requirements being equal to or larger than mpe-Threshold in this MAC entity in which case the PHR is referred below to as ‘MPE P-MPR report’.

NOTE 2: The MAC entity should avoid triggering a PHR when the required power backoff due to power management decreases only temporarily (e.g., for up to a few tens of milliseconds) and it should avoid reflecting such temporary decrease in the values of P_{CMAX,ƒ,c}/PH when a PHR is triggered by other triggering conditions.

NOTE 3: If a HARQ process is configured with eg-RetransmissionTimer and if the PHR is already included in a MAC PDU for transmission on configured grant by this HARQ process, but not yet transmitted by lower layers, it is up to wireless device implementation how to handle the PHR content.

### [Description Ends]

According to 3GPP standards such as, for example, 3GPP TS 38.331 v17.1.0 2022-06 the PHR config is described below.

### [Description Starts]

PHR-Config

The IE PHR-Config is used to configure parameters for power headroom reporting.

### PHR-Config Information Element

-- ASN1START
-- TAG-PHR-CONFIG-START

| | |
|---|---|
| PHR-Config ::= | SEQUENCE { |
| phr-PeriodicTimer | ENUMERATED {sf10, sf20, sf50, sf100, sf200,sf500, |

sf1000, infinity},

| | |
|---|---|
| phr-ProhibitTimer | ENUMERATED {sf0, sf10, sf20, sf50, sf100,sf200, |

sf500, sf1000},

| | |
|---|---|
| phr-Tx-PowerFactorChange | ENUMERATED {dB1, dB3, dB6, infinity}, |
| multiplePHR | BOOLEAN, |
| dummy | BOOLEAN, |
| phr-Type2OtherCell | BOOLEAN, |
| phr-ModeOtherCG | ENUMERATED {real, virtual}, |

```
  ...,
  [[
```

| | |
|---|---|
| mpe-Reporting-FR2-r16 | SetupRelease { MPE-Config-FR2-r16 } |

```
OPTIONAL -- Need M
  ]],
  [[
```

| | |
|---|---|
| mpe-Reporting-FR2-r17 | SetupRelease { MPE-Config-FR2-r17 } |

OPTIONAL, -- Need M

| | |
|---|---|
| twoPHRMode-r17 | ENUMERATED {enabled} |

OPTIONAL -- Need R
]]
}

| | |
|---|---|
| MPE-Config-FR2-r16 ::= | SEQUENCE { |
| mpe-ProhibitTimer-r16 | ENUMERATED {sf0, sf10, sf20, sf50, sf100, sf200, |

sf500, sf1000},

| | |
|---|---|
| mpe-Threshold-r16 | ENUMERATED {dB3, dB6, dB9, dB12} |

}

| | |
|---|---|
| MPE-Config-FR2-r17 ::= | SEQUENCE { |
| mpe-ProhibitTimer-r17 | ENUMERATED {sf0, sf10, sf20, sf50, sf100, sf200, |

sf500, sf1000},
mpe-Threshold-r17

| | |
|---|---|
| numberOfN-r17 | ENUMERATED {dB3, dB6, dB9, dB12}, |
| ... | INTEGER(1..4), |

}
-- TAG-PHR-CONFIG-STOP
-- ASN1STOP

PHR-Config field descriptions

dummy
This field is not used in this version of the specification and the wireless
device ignores the received value.
mpe-ProhibitTimer
Value in number of subframes for MPE reporting, as specified in 3GPP TS
38.321. Value sf10 corresponds to 10 subframes, and so on.
mpe-Reporting-FR2
Indicates whether the WD shall report MPE P-MPR in the PHR MAC control
element, as specified in 3GPP TS 38.321.
mpe-Threshold
Value of the P-MPR threshold in dB for reporting MPE P-MPR when FR2 is
configured, as specified in 3GPP TS 38.321. The same value applies for each
serving cell (although the associated functionality is performed independently
for each cell).
multiplePHR
Indicates if power headroom shall be reported using the Single Entry PHR MAC
control element or Multiple Entry PHR MAC control element defined in 3GPP
TS 38.321. True means to use Multiple Entry PHR MAC control element and
False means to use the Single Entry PHR MAC control element defined in 3GPP
TS 38.321. The network configures this field to true for MR-DC and UL CA for
NR, and to false in all other cases.
numberOfN
Number of reported P-MPR values in a PHR MAC CE.
phr-ModeOtherCG
Indicates the mode (i.e., real or virtual) used for the PHR of the activated cells
that are part of the other Cell Group (i.e., MCG or SCG), when DC is configured.
If the wireless device is configured with only one cell group (no DC), it ignores
the field.
phr-PeriodicTimer
Value in number of subframes for PHR reporting as specified in 3GPP TS
38.321. Value sf10 corresponds to 10 subframes, value sf20 corresponds to 20
subframes, and so on.
phr-ProhibitTimer
Value in number of subframes for PHR reporting as specified in 3GPP TS
38.321. Value sf0 corresponds to 0 subframe, value sf10 corresponds to 10
subframes, value sf20 corresponds to 20 subframes, and so on.
phr-Tx-PowerFactorChange
Value in dB for PHR reporting as specified in 3GPP TS 38.321. Value dB 1
corresponds to 1 dB, dB 3 corresponds to 3 dB and so on. The same value applies
for each serving cell (although the associated functionality is performed
independently for each cell).
phr-Type2OtherCell
If set to true, the wireless device reports a PHR type 2 for the SpCell of the other
MAC entity. See 3GPP TS 38.321, clause 5.4.6. Network sets this field to false if
the wireless device is not configured with an E-UTRA MAC entity.
twoPHRMode
Indicates if the power headroom shall be reported as two PHRs (each PHR
associated with a SRS resource set) is enabled or not.

### [Description Ends]

The PHR is reported for PUSCH (Type 1) and SRS (Type 3). PH can be either single-entry (for a serving cell) or multi-entry including serving cells of a MR-DC or UL CA band combination. The latter is configured for the said band combinations, otherwise single-entry.

The PHR can be either periodic (typically 20-50 ms) or triggered with phr-PeriodicTimer by events such as DL path loss changes affecting the UL power required or a P-MPR change if this is above a configurable threshold value. According to 3GPP standards such as, for example, 3GPP TS 38.321 v17.1.0 2022-06, a PHR is triggered if any of the following events occur:
phr-ProhibitTimer expires or has expired and the path loss has changed more than phr-Tx-PowerFactorChange dB [configurable threshold] for at least one RS used as pathloss reference for one activated Serving Cell of any MAC entity of which the active DL BWP is not dormant BWP since the last transmission of a PHR in this MAC entity when the MAC entity has UL resources for new transmission.

Relating to SAR and MPE compliance, a PHR is also triggered if the P-MPR is changed more than a configurable threshold with phr-Tx-PowerFactorChange for more than a few tenths of milliseconds (SAR a long-term average) when the wireless device has UL resources for new transmission as described in 3GPP standards such as in, for example, 3GPP TS 38.321 v17.1.0 2022-06:
there are UL resources allocated for transmission or there is a PUCCH transmission on this cell, and the required power backoff due to power management (as allowed by P-MPR_{c} as specified in 3GPP standards such as in, for example, 3GPP TS 38.101-1, 3GPP TS 38.101-2, and 3GPP TS 38.101-3) for this cell has changed more than phr-Tx-PowerFactorChange dB since the last transmission of a PHR when the MAC entity had UL resources allocated for transmission or PUCCH transmission on this cell.

The power capability change ΔP_{powerclass} affects the actual wireless device power capability for transmissions, the reported PHR and hence the uplink scheduling by the network node for a serving cell, the application of ΔP_{powerclass} in time up to wireless device implementation. The network node is therefore not aware of the time instant at which the wireless device applies the ΔP_{powerclass}, which leads to a misalignment between the power reported to (and assumed by) a network node and the actual power available from the wireless device.

The ΔP_{powerclass} is not indicated explicitly in the PHR like the P-MPR (the “P-bit”). Even though the ΔP_{powerclass} is implicitly included in the reported P_{CMAX,ƒ,c}, the P_{CMAX,ƒ,c} contains other factors where application of ΔP_{powerclass} cannot be inferred from the value P_{CMAX,ƒ,c} for an actual transmission.

Further, changes of the power capability P_{powerclass,CA} for a band combination can imply changes ΔP_{powerclass} for the serving cells or that serving cell uplink power is prioritized (reduced), the time instant of which is not specified.

As such, existing power headroom reporting procedures are not without issues.

### SUMMARY

Some embodiments advantageously provide methods and wireless devices (WDs) for a reporting of a power class modification.

In some embodiments, a power capability modification ΔP_{powerclass} is provided for a serving cell or ΔP_{powerclass,CA} for a band combination to and from a first power capability to a second power capability among a plurality of power capabilities that trigger a PHR according to a network node configuration (power-class fallback reporting).

In some embodiments, reserved bits of the PHR are used for indicating that ΔP_{powerclass} for a serving cell or ΔP_{powerclass,CA} for a band are applied so as to distinguish the PHR trigger event from other events triggering a PHR and to inform the network node on the ΔP_{powerclass} applied. The indication, if applied, may also be included in periodic PH reports.

According to one aspect, a WD configured to communicate with a network node is provided. The WD is configured to trigger a first power headroom report, PHR, when a prohibit timer has expired and at least one power class fallback value exceeds a threshold. The WD is configured to transmit the first PHR.

According to this aspect, in some embodiments, the at least one power class value corresponds to at least one of an activated serving cell and a configured band combination with at least one activated serving cell. In some embodiments, the first PHR indicates a power class fallback value of at least one of the activated serving cell and the configured band combination. In some embodiments, two reserved bits are used to indicate the power class fallback value for the activated serving cell, and one reserved bit is used to indicate the power class fallback value for the configured band combination. In some embodiments, when two reserved bits are used to indicate the power class fallback value for the activated serving cell, the indicated power class fallback value being at least one of 0, 3, and 6 dB; and when one reserved bit is used to indicate the power class fallback value for the configured band combination, the indicated power class fallback value being one of 0 dB or a value configured by higher layer signaling. In some embodiments, when the indicated power class fallback value is a value configured by higher layer signaling, the indicated power class fallback value being equivalent to a threshold. In some embodiments, the PHR is triggered when there is at least one activated serving cell of a medium access control, MAC, entity for which an active uplink bandwidth part, UL BWP, has not been dormant since a second PHR previous to the first PHR was transmitted in the MAC entity and the WD has uplink resources for transmitting the first PHR. In some embodiments, the PHR is triggered when there is a configured band combination with at least one activated serving cell of a medium access control, MAC, entity for which active uplink bandwidth parts, UL BWPs, have not been dormant since the a second PHR previous to the first PHR was reported in the MAC entity and the WD has uplink resources for transmitting the first PHR. In some embodiments, the MAC entity indicates whether a power headroom value in the first PHR is for an activated serving cell based at least in part on a transmission or a reference format. In some embodiments, the MAC entity includes at least one power headroom field indicating at least one power class fallback value change. In some embodiments, at least power class value change is based at least in part on a change in pathloss. In some embodiments, the prohibit timer is a power class change timer having a duration being a minimum duration between power headroom reports. In some embodiments, the PHR includes reserved bits to enable the network node to distinguish the first PHR from another PHR triggered by other events. In some embodiments, the first PHR includes reserved bits to enable the network node to distinguish the first PHR from a periodic PHR.

According to another aspect, a method in a wireless device, WD, configured to communicate with a network node is provided. The method includes triggering a first power headroom report, PHR, when a prohibit timer has expired and at least one power class fallback value exceeds a threshold. The method also includes transmitting the first PHR.

According to this aspect, in some embodiments, the at least one power class value corresponds to at least one of an activated serving cell and a configured band combination with at least one activated serving cell. In some embodiments, the first PHR indicates a power class fallback value of at least one of the activated serving cell and the configured band combination. In some embodiments, two reserved bits are used to indicate the power class fallback value for the activated serving cell, and one reserved bit is used to indicate the power class fallback value for the configured band combination. In some embodiments, when two reserved bits are used to indicate the power class fallback value for the activated serving cell, the indicated power class fallback value being at least one of 0, 3, and 6 dB; and when one reserved bit is used to indicate the power class fallback value for the configured band combination, the indicated power class fallback value being one of 0 dB or a value configured by higher layer signaling. In some embodiments, when the indicated power class fallback value is a value configured by higher layer signaling, the indicated power class fallback value being equivalent to a threshold. In some embodiments, the PHR is triggered when there is at least one activated serving cell of a medium access control, MAC, entity for which an active uplink bandwidth part, UL BWP, has not been dormant since a second PHR previous to the first PHR was transmitted in the MAC entity and the WD has uplink resources for transmitting the first PHR. In some embodiments, the PHR is triggered when there is a configured band combination with at least one activated serving cell of a medium access control, MAC, entity for which active uplink bandwidth parts, UL BWPs, have not been dormant since the a second PHR previous to the first PHR was reported in the MAC entity and the WD has uplink resources for transmitting the first PHR. In some embodiments, the MAC entity indicates whether a power headroom value in the first PHR is for an activated serving cell based at least in part on a transmission or a reference format. In some embodiments, the MAC entity includes at least one power headroom field indicating at least one power class fallback value change. In some embodiments, at least power class value change is based at least in part on a change in pathloss. In some embodiments, the prohibit timer is a power class change timer having a duration being a minimum duration between power headroom reports. In some embodiments, the PHR includes reserved bits to enable the network node to distinguish the first PHR from another PHR triggered by other events. In some embodiments, the first PHR includes reserved bits to enable the network node to distinguish the first PHR from a periodic PHR.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a flowchart of an example process in a wireless device according to some embodiments of the present disclosure;

FIG. 9 is a flowchart of another example process in a wireless device according to some embodiments of the present disclosure;

FIG. 10 is a diagram of a power class change from a high power class to a lower power class to trigger PHR;

FIG. 11 is a diagram of a power class change from a lower power class to a high power class to trigger PHR;

FIG. 12 is a diagram of single entry PHR MAC CE;

FIG. 13 is a diagram of a multiple entry PHR MAC CE with the highest ServCellIndex of serving cell with configured uplink less than 8;

FIG. 14 is a diagram of a single entry PHR MAC CE;

FIG. 15 is a diagram of a multiple entry PHR MAC CE with a highest ServCellIndex of a serving cell with configured uplink less than 8; and

FIG. 16 is a diagram of a multiple entry PHR MAC CE with a highest ServCellIndex of serving cell with configured uplink equal to or higher than 8.

### DETAILED DESCRIPTION

Before describing in detail example embodiments, it is noted that the embodiments reside primarily in combinations of apparatus components and processing steps related to a reporting of a power class modification. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide a reporting of a power class modification.

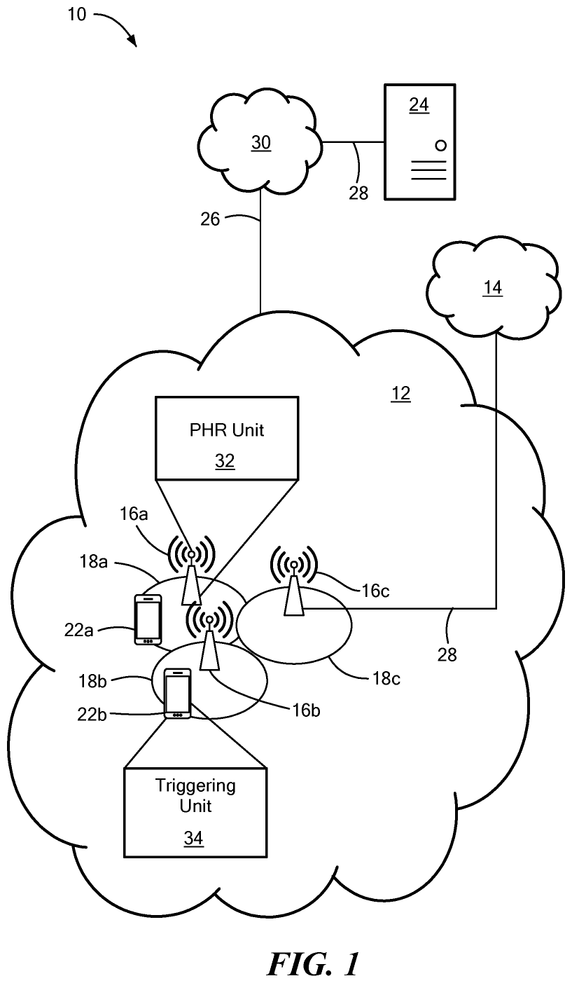

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a PHR unit 32 which is configured to perform one or more network node 16 functions as described herein such as with respect to a reporting of a power class modification. A wireless device 22 is configured to include an triggering unit 34 which is configured to perform one or more wireless device 22 functions as described herein such as with respect to a reporting of a power class modification. For example, the triggering unit 34 may be configured to trigger a PHR when a prohibit timer has expired and at least one power class fallback value exceeds a threshold.

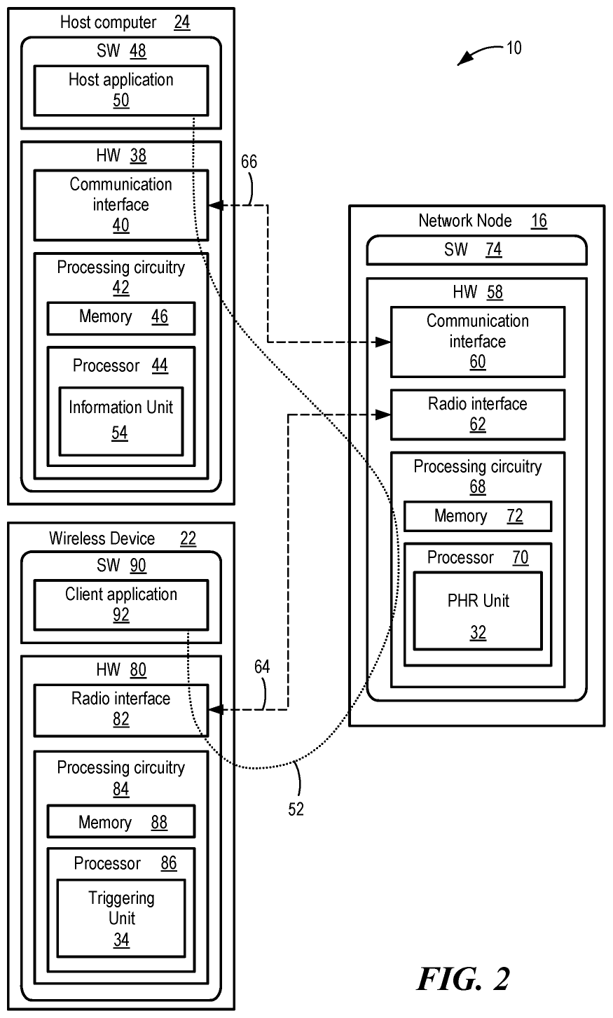

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to analyze, determine, store, forward, relay, transmit, receive, etc. information associated with a reporting of a power class modification.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include power headroom report (PHR) unit 32 configured to perform one or more network node 16 functions as described herein such as with respect to a reporting of a power class modification.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an triggering unit 34 configured to perform one or more wireless device 22 functions as described herein such as with respect to a reporting of a power class modification. For example, the triggering unit 34 may be configured to trigger a PHR when a prohibit timer has expired and at least one power class fallback value exceeds a threshold.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as PHR unit 32, and triggering unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

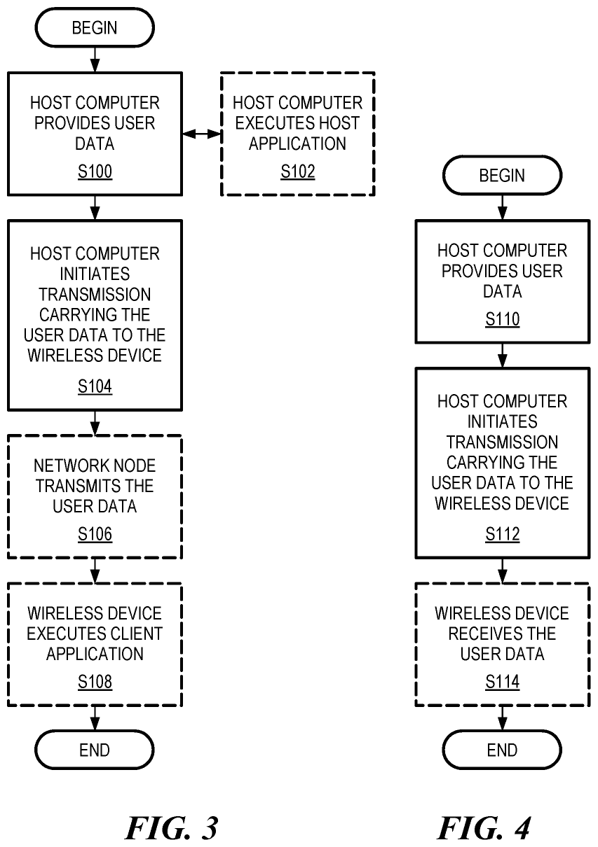

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

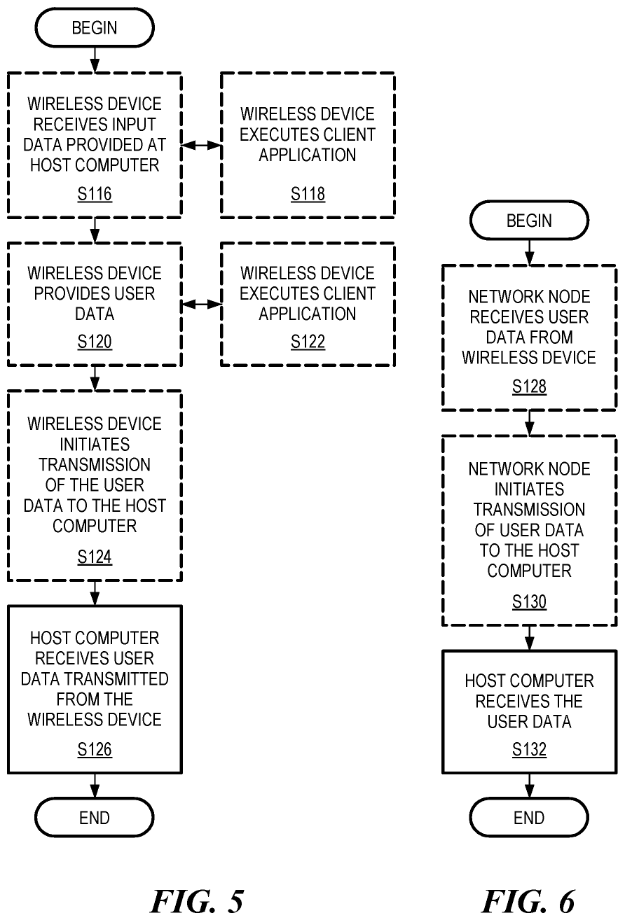

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

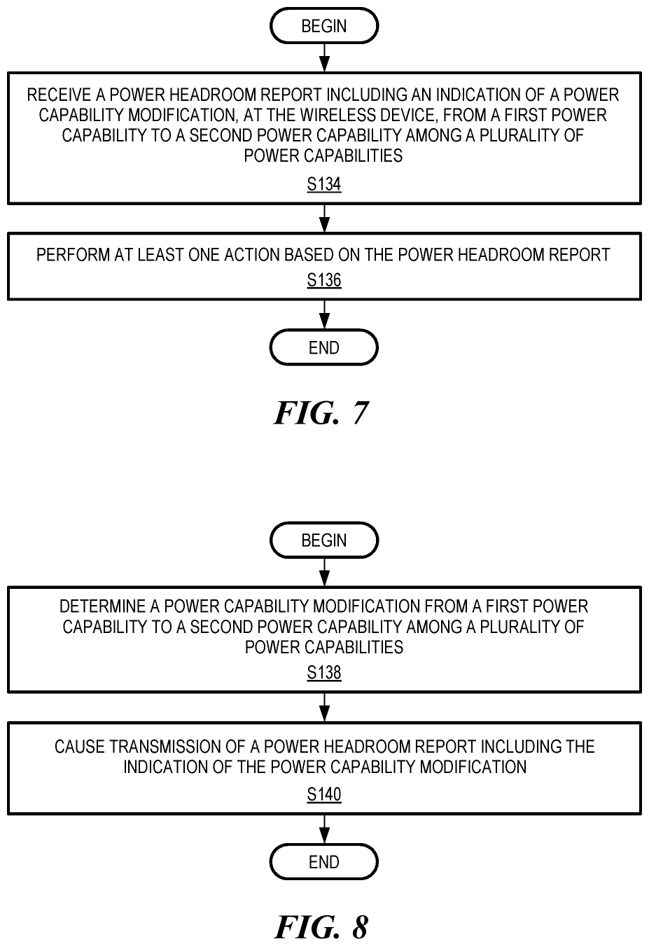

FIG. 7 is a flowchart of an example process in a network node 16 according to some embodiments of the present disclosure. One or more blocks described herein may be performed by one or more elements of network node 16 such as by one or more of processing circuitry 68 (including the PHR unit 32), processor 70, radio interface 62 and/or communication interface 60. Network node 16 receive (Block S134) a power headroom report including an indication of a power capability modification, at the wireless device 22, from a first power capability to a second power capability among a plurality of power capabilities, as described herein. Network node 16 is configured to perform (Block S136) at least one action based at least in part on the power headroom report, as described herein.

According to one or more embodiments, the power capability modification corresponds to an actual power available at the wireless device 22.

According to one or more embodiments, the power headroom report includes at least one preconfigured reserved bit, the indication being provided in the at least one preconfigured reserved bit.

According to one or more embodiments, the indication is configured to distinguish a power headroom report trigger event from other events that trigger the power headroom report.

According to one or more embodiments, the power capability modification corresponds to one of: a ΔP_{powerclass} for a serving cell and a ΔP_{powerclass,CA} for a band combination

FIG. 8 is a flowchart of an example process in a wireless device 22 according to some embodiments of the present disclosure. One or more blocks described herein may be performed by one or more elements of wireless device 22 such as by one or more of processing circuitry 84 (including the triggering unit 34), processor 86, radio interface 82 and/or communication interface 60. Wireless device 22 is configured to determine (Block S138) a power capability modification from a first power capability to a second power capability among a plurality of power capabilities, as described herein. Wireless device 22 is configured to cause (Block S140) transmission of a power headroom report including the indication of the power capability modification, as described herein.

According to one or more embodiments, power capability modification corresponds to an actual power available at the wireless device 22.

According to one or more embodiments, the power headroom report includes at least one preconfigured reserved bit, the indication being provided in the at least one preconfigured reserved bit.

According to one or more embodiments, the indication is configured to distinguish a power headroom report trigger event from other events that trigger the power headroom report.

According to one or more embodiments, the power capability modification corresponds to one of: a ΔP_{powerclass} for a serving cell; and a ΔP_{powerclass,CA} for a band combination.

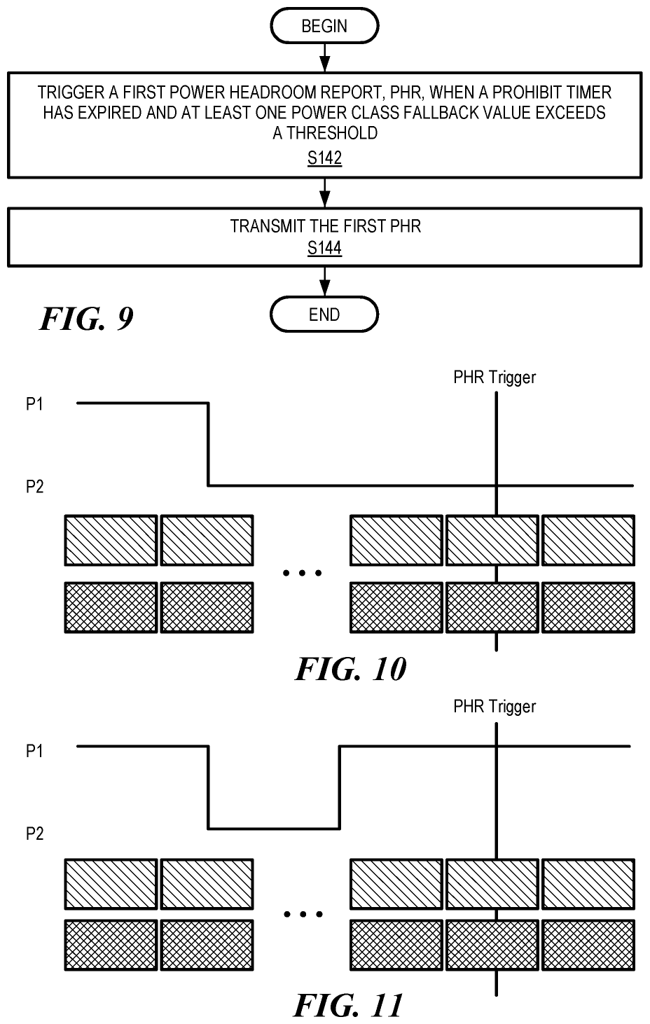

FIG. 9 is a flowchart of an example process in a wireless device 22 according to some embodiments of the present disclosure. One or more blocks described herein may be performed by one or more elements of wireless device 22 such as by one or more of processing circuitry 84 (including the triggering unit 34), processor 86, radio interface 82 and/or communication interface 60. Wireless device 22 is configured to trigger (Block S142) a first power headroom report, PHR, when a prohibit timer has expired and at least one power class fallback value exceeds a threshold. The method also includes transmitting (Block S144) the first PHR.

According to this aspect, in some embodiments, the at least one power class value corresponds to at least one of an activated serving cell and a configured band combination with at least one activated serving cell. In some embodiments, the first PHR indicates a power class fallback value of at least one of the activated serving cell and the configured band combination. In some embodiments, two reserved bits are used to indicate the power class fallback value for the activated serving cell, and one reserved bit is used to indicate the power class fallback value for the configured band combination. In some embodiments, when two reserved bits are used to indicate the power class fallback value for the activated serving cell, the indicated power class fallback value being at least one of 0, 3, and 6 dB; and when one reserved bit is used to indicate the power class fallback value for the configured band combination, the indicated power class fallback value being one of 0 dB or a value configured by higher layer signaling. In some embodiments, when the indicated power class fallback value is a value configured by higher layer signaling, the indicated power class fallback value being equivalent to a threshold. In some embodiments, the PHR is triggered when there is at least one activated serving cell of a medium access control, MAC, entity for which an active uplink bandwidth part, UL BWP, has not been dormant since a second PHR previous to the first PHR was transmitted in the MAC entity and the WD 22 has uplink resources for transmitting the first PHR. In some embodiments, the PHR is triggered when there is a configured band combination with at least one activated serving cell of a medium access control, MAC, entity for which active uplink bandwidth parts, UL BWPs, have not been dormant since the a second PHR previous to the first PHR was reported in the MAC entity and the WD 22 has uplink resources for transmitting the first PHR. In some embodiments, the MAC entity indicates whether a power headroom value in the first PHR is for an activated serving cell based at least in part on a transmission or a reference format. In some embodiments, the MAC entity includes at least one power headroom field indicating at least one power class fallback value change. In some embodiments, at least power class value change is based at least in part on a change in pathloss. In some embodiments, the prohibit timer is a power class change timer having a duration being a minimum duration between power headroom reports. In some embodiments, the PHR includes reserved bits to enable the network node to distinguish the first PHR from another PHR triggered by other events. In some embodiments, the first PHR includes reserved bits to enable the network node to distinguish the first PHR from a periodic PHR.

Having described the general process flow of arrangements of the disclosure and having provided examples of hardware and software arrangements for implementing the processes and functions of the disclosure, the sections below provide details and examples of arrangements for a reporting of a power class modification.

Some embodiments provide a reporting of a power class modification. One or more wireless device 22 functions described below may be performed by one or more of processing circuitry 84, processor 86, triggering unit 34, radio interface 82, etc. One or more network node 16 functions described below may be performed by one or more of processing circuitry 68, processor 70, PHR unit 32, radio interface 62, etc.

The wireless device 22 is connected to, i.e., in communication with, a network node 16 that has configured a PHR for a cell group consisting of one or more serving cells. For an Evolved Universal Terrestrial Radio Access-New Radio-Dual Connectivity (EN-DC) or NR UL CA configuration a multi-entry PHR is configured, otherwise a single-entry PHR is configured. When the network node 16 configures powerClassFallBackReporting for the PHR for the purpose of power-class fallback reporting, a threshold phr-Tx-BandPowerClassChange dB is configured for serving cells (one or more) and phr-Tx-PowerClassChange for a band combination if configured. Absence of powerClassFallBackReporting means that power-class reporting is not configured.

A PHR is triggered whenever the wireless device 22 is changing the power class by a ΔP_{powerclass} of at least phr-Tx-BandPowerClassChange dB for a serving cell or by a ΔP_{powerclass,CA} of at least phr-Tx-PowerClassChange for a band combination in the configured maximum output power for the wireless device 22.

FIG. 10 is a diagram of an example a power class change from a high power class to a low power class that triggers PHR. FIG. 11 is a diagram of an example power class change from a low-power class to high-power class that triggers PHR.

The procedure in 3GPP such as in, for example, 3GPP TS 38.321 v17.1.0 2022-06 is as follows:

### <Start of Change>

A Power Headroom Report (PHR) is triggered if any of the following events occur:
phr-ProhibitTimer expires or has expired and the path loss has changed more than phr-Tx-PowerFactorChange dB for at least one RS used as pathloss reference for one activated Serving Cell of any MAC entity of which the active DL BWP is not dormant BWP since the last transmission of a PHR in this MAC entity when the MAC entity has UL resources for new transmission;

### [First Version Reusing Phr-ProhibitTimer]

phr-ProhibitTimer expires or has expired and the power class has changed by at least phr-Tx-BandPowerClassChange dB for at least one activated Serving Cell of any MAC entity of which the active UL BWP is not dormant BWP since the last transmission of a PHR in this MAC entity when the MAC entity has UL resources for new transmission;
phr-ProhibitTimer expires or has expired and the power class has changed by at least phr-Tx-PowerClassChange dB for a configured band combination with at least one activated Serving Cell of any MAC entity of which active UL BWPs are not dormant BWP since the last transmission of a PHR in this MAC entity when the MAC entity has UL resources for new transmission;
   [Second Version with New Timer for Dpc Dpc-ProhibitTimer]
dpc-ProhibitTimer expires or has expired and the power class has changed by at least phr-Tx-BandPowerClassChange dB for at least one activated Serving Cell of any MAC entity of which the active UL BWP is not dormant BWP since the last transmission of a PHR in this MAC entity when the MAC entity has UL resources for new transmission;
dpc-ProhibitTimer expires or has expired and the power class has changed by at least phr-Tx-PowerClassChange dB for a configured band combination with at least one activated Serving Cell of any MAC entity of which active UL BWPs are not dormant BWP since the last transmission of a PHR in this MAC entity when the MAC entity has UL resources for new transmission;

### <End of Change>

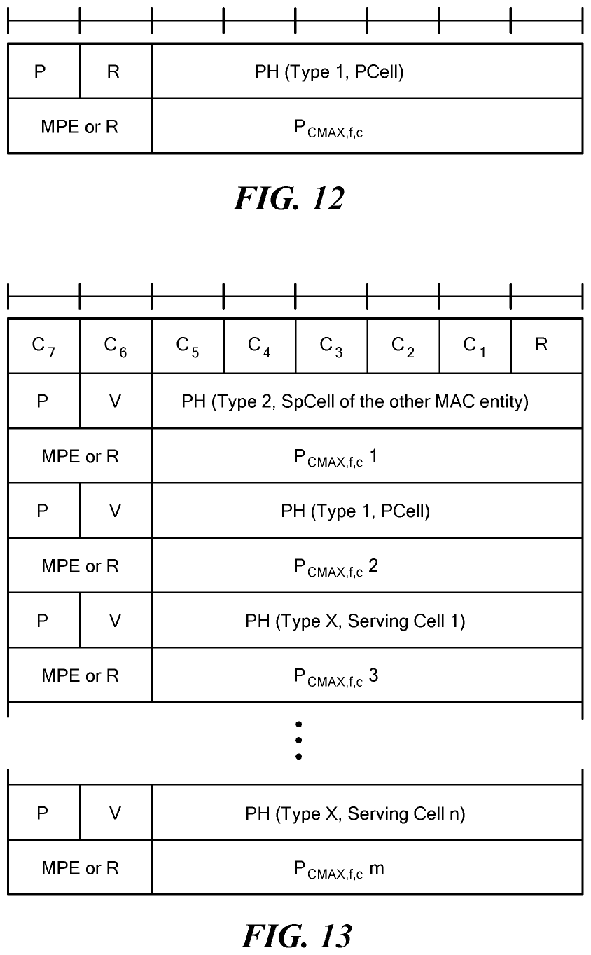

FIG. 12 is a diagram of a single entry PHR MAC CE.

When powerClassFallBackReporting is configured (and with mpe-Reporting-FR2 not configured), spare bits in the single-entry and multiple-entry PHR may be used to inform the network node 16 that the PHR is triggered by a power-class change.

For a single-entry PHR, the MPE is replaced by a power-class fallback value ΔP_{powerclass}=0, 3, 6, mapped as shown in Table 1, the fourth value can be reserved. The fallback value affects the P_{CMAX,ƒ,c}.

TABLE 1
Power class fallback values in the PHR (MPE absent)

| D-PC | Power-class fallback value |
|---|---|
| 0 | D-PwrClass_00 |
| 1 | D-PwrClass_01 |
| 2 | D- PwrClass_02 |
| 3 | D-PwrClass_03 |

FIG. 13 is a diagram of the multi-entry PHR being modified in a similar way (a band combination configured) for the serving cells, where the multiple entry PHR MAC CE with the highest ServCellIndex of a serving cell with configured uplink is less than 8.

The spare bit R in the first octet is replaced by a D-PC-pc bit that takes the value “1” in case the wireless device 22 is changing the power class by a ΔP_{powerclass,CA} of at least phr-Tx-PowerClassChange, “0” otherwise.

The field phr-Tx-PowerClassChange can be an information element (IE) with values defined for each configured serving cell Cᵢ (a sequence) in a band combination.

The nominal wireless device 22 power level P_{CMAX,ƒ,c} for a serving cell is reported using the standard values with account of the changed power class.

A change of the ΔP_{powerclass,CA} does not necessitate a change of the ΔP_{powerclass} for a serving cell.

The functionality of the P-bit is unchanged, but the P-MPR is set with regard to the level P_{CMAX,ƒ,c} possibly modified by power-class fallback.

The power-class fallback report in the 3GPP standards such as, for example, 3GPP TS 38.321 v17.1.0 2022-06 as follows for the case that fallback reporting is specified for serving cells in FR1 (Frequency Range 1 as specified in 3GPP standards, such as, for example, 3GPP TS 38.101-1 v17.6.0 2022-06):

### <Start of Change>

### Single Entry PHR MAC CE

The Single Entry PHR MAC CE is identified by a MAC subheader with LCID as specified in Table 2.

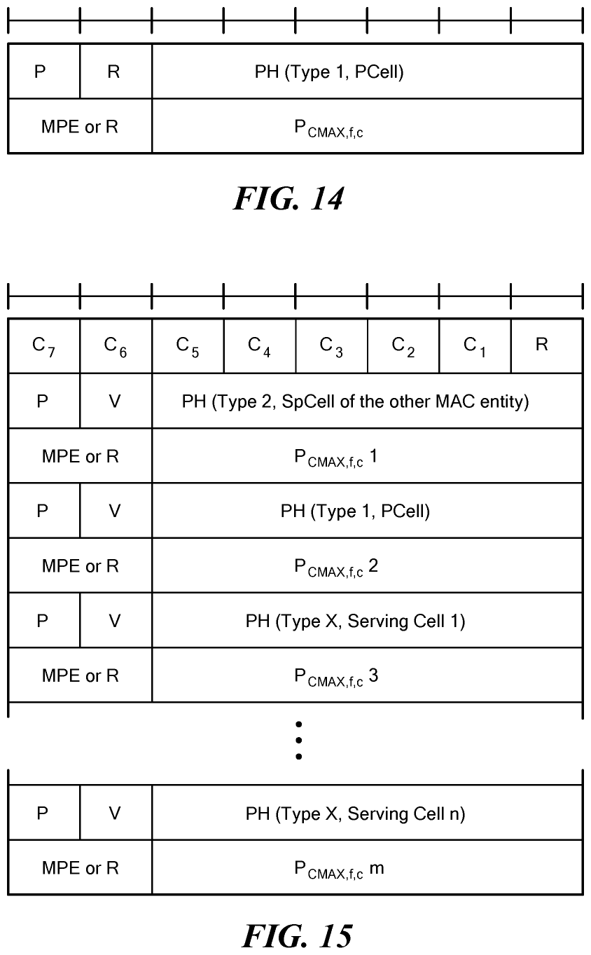

It has a fixed size and consists of two octets defined as follows (FIG. 14):
R: Reserved bit, set to 0;
Power Headroom (PH): This field indicates the power headroom level. The length of the field is 6 bits. The reported PH and the corresponding power headroom levels are shown in Table 2 (the corresponding measured values in dB are specified in 3GPP standards such as in, for example, 3GPP TS 38.133);
P: If mpe-Reporting-FR2 is configured and the Serving Cell operates on FR2, the MAC entity sets this field to 0 if the applied P-MPR value, to meet MPE requirements, as specified in 3GPP standards such as in, for example, 3GPP TS 38.101-2, is less than P-MPR_00 as specified in 3GPP standards such as in, for example, 3GPP TS 38.133 and to 1 otherwise. If mpe-Reporting-FR2 is not configured or the Serving Cell operates on FR1, this field indicates whether power backoff is applied due to power management (as allowed by P-MPR_{c} as specified in 3GPP standards such as in, for example, 3GPP TS 38.101-1, 3GPP TS 38.101-2, and 3GPP TS 38.101-3). The MAC entity sets the P field to 1 if the corresponding P_{CMAX,ƒ,c} field would have had a different value if no power backoff due to power management had been applied;
P_{CMAX,ƒ,c}: This field indicates the P_{CMAX,ƒ,c} (as specified in 3GPP standards such as in 3GPP TS 38.213) used for calculation of the preceding PH field. The reported P_{CMAX,ƒ,c} and the corresponding nominal wireless device 22 transmit power levels are shown in Table 3 (the corresponding measured values in dBm are specified in 3GPP standards such as in, for example, 3GPP TS 38.133);
MPE: If mpe-Reporting-FR2 is configured, and the Serving Cell operates on FR2, and if the P field is set to 1, this field indicates the applied power backoff to meet MPE requirements, as specified in 3GPP standards such as in, for example, 3GPP TS 38.101-2. This field indicates an index to Table 4 and the corresponding measured values of P-MPR levels in dB are specified in 3GPP standards such as in, for example, 3GPP TS 38.133. The length of the field is 2 bits. If mpe-Reporting-FR2 is not configured, or if the Serving Cell operates on FR1, or if the P field is set to 0, R bits are present instead.
D-PC: If powerClassFallBackReporting is configured, and the Serving Cell operates on FR1, this field indicates the applied power class-fallback, as specified in 3GPP standards such as in, for example, 3GPP TS 38.101-1. This field indicates an index to Table 5 and the corresponding power-class fallback levels in dB are specified in 3GPP standards such as in, for example, 3GPP TS 38.133. The length of the field is 2 bits. If powerClassFallBackReporting is not configured, or if the Serving Cell operates on FR2, R bits are present instead.

TABLE 2
Power Headroom levels for PHR

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| . . . | . . . |
| 60 | POWER_HEADROOM_60 |
| 61 | POWER_HEADROOM_61 |
| 62 | POWER_HEADROOM_62 |
| 63 | POWER_HEADROOM_63 |

TABLE 3
Nominal wireless device transmit power level for PHR

| P_{CMAX, f, c} | Nominal WD transmit power level |
|---|---|
| 0 | PCMAX_C_00 |
| 1 | PCMAX_C_01 |
| 2 | PCMAX_C_02 |
| . . . | . . . |
| 61 | PCMAX_C_61 |
| 62 | PCMAX_C_62 |
| 63 | PCMAX_C_63 |

TABLE 4
Effective power reduction for MPE P-MPR

| MPE | Measured P-MPR value |
|---|---|
| 0 | P-MPR_00 |
| 1 | P-MPR_01 |
| 2 | P-MPR_02 |
| 3 | P-MPR_03 |

TABLE 5
Power class fallback values

| D-PC | Power-class fallback value |
|---|---|
| 0 | D-PwrClass_00 |
| 1 | D-PwrClass_01 |
| 2 | D- PwrClass_02 |
| 3 | D-PwrClass_03 |

### Multiple Entry PHR MAC CE

The Multiple Entry PHR MAC CE is identified by a MAC subheader with logical channel ID (LCID) as specified in Table 6.2.1-2 of 3GPP standards such as in, for example, 3GPP TS 38.321 v17.1.0 2022-06.

It has a variable size, and includes the bitmap, a Type 2 PH field and an octet containing the associated P_{CMAX,ƒ,c} field (if reported) for SpCell of the other MAC entity, a Type 1 PH field and an octet containing the associated P_{CMAX,ƒ,c} field (if reported) for the PCell. It further includes, in ascending order based on the ServCellIndex, one or multiple of Type X PH fields and octets containing the associated P_{CMAX,ƒ,c} fields (if reported) for Serving Cells other than PCell indicated in the bitmap. X is either 1 or 3 according to 3GPP standards such as, for example, 3GPP TS 38.213 and 3GPP TS 36.213.

The presence of Type 2 PH field for SpCell of the other MAC entity is configured by phr-Type2OtherCell with value true.

A single octet bitmap is used for indicating the presence of PH per Serving Cell when the highest ServCellIndex of Serving Cell with configured uplink is less than 8, otherwise four octets are used.

The MAC entity determines whether PH value for an activated Serving Cell is based on real transmission or a reference format by considering the configured grant(s) and downlink control information which has been received until and including the PDCCH occasion in which the first UL grant for a new transmission that can accommodate the MAC CE for PHR as a result of LCP, for example, as defined in 3GPP standards is received since a PHR has been triggered if the PHR MAC CE is reported on an uplink grant received on the PDCCH or until the first uplink symbol of PUSCH transmission minus PUSCH preparation time as defined in 3GPP standards such as, for example, clause 7.7 of 3GPP TS 38.213, if the PHR MAC CE is reported on a configured grant.

For a band combination in which the wireless device 22 does not support dynamic power sharing, the wireless device 22 may omit the octets containing Power Headroom field and P_{CMAX,ƒ,c} field for Serving Cells in the other MAC entity except for the PCell in the other MAC entity and the reported values of Power Headroom and P_{CMAX,ƒ,c} for the PCell are up to wireless device 22 implementation.

The PHR MAC CEs are defined as follows:
Cᵢ: This field indicates the presence of a PH field for the Serving Cell with ServCellIndex i as specified in 3GPP standards such as, for example, 3GPP TS 38.331. The Cᵢ field set to 1 indicates that a PH field for the Serving Cell with ServCellIndex i is reported. The Cᵢ field set to 0 indicates that a PH field for the Serving Cell with ServCellIndex i is not reported;
R: Reserved bit, set to 0;
D-PC-bc: If powerClassFallBackReporting is configured, and the wireless device 22 is configured with a band combination. This field indicates that the wireless device 22 applies power class-fallback for this band combination, as specified in 3GPP standards such as in, for example, 3GPP TS 38.101-1. The length of the field is 1 bit. If powerClassFallBackReporting is not configured, an R bit is present instead.
V: This field indicates if the PH value is based on a real transmission or a reference format. For Type 1 PH, the V field set to 0 indicates real transmission on PUSCH and the V field set to 1 indicates that a PUSCH reference format is used. For Type 2 PH, the V field set to 0 indicates real transmission on PUCCH and the V field set to 1 indicates that a PUCCH reference format is used. For Type 3 PH, the V field set to 0 indicates real transmission on SRS and the V field set to 1 indicates that an SRS reference format is used. Furthermore, for Type 1, Type 2, and Type 3 PH, the V field set to 0 indicates the presence of the octet containing the associated P_{CMAX,ƒ,c} field and the MPE field, and the V field set to 1 indicates that the octet containing the associated P_{CMAX,ƒ,c} field and the MPE field is omitted;
Power Headroom (PH): This field indicates the power headroom level. The length of the field is 6 bits. The reported PH and the corresponding power headroom levels are shown in Table 2 (the corresponding measured values in dB for the NR Serving Cell are specified in 3GPP standards such as in, for example, 3GPP TS 38.133 while the corresponding measured values in dB for the E-UTRA Serving Cell are specified in 3GPP standards such as in, for example, 3GPP TS 36.133);
P: If mpe-Reporting-FR2 is configured and the Serving Cell operates on FR2, the MAC entity sets this field to 0 if the applied P-MPR value, to meet MPE requirements, as specified in 3GPP standards such as in, for example, 3GPP TS 38.101-2, is less than P-MPR_00 as specified in 3GPP standards such as in, for example, 3GPP TS 38.133 and to 1 otherwise. If mpe-Reporting-FR2 is not configured or the Serving Cell operates on FR1, this field indicates whether power backoff is applied due to power management (as allowed by P-MPR_{c} as specified in 3GPP standards such as in, for example, 3GPP TS 38.101-1, 3GPP TS 38.101-2, and 3GPP TS 38.101-3). The MAC entity shall set the P field to 1 if the corresponding P_{CMAX,ƒ,c} field would have had a different value if no power backoff due to power management had been applied;
P_{CMAX,ƒ,c}: If present, this field indicates the P_{CMAX,ƒ,c} (as specified in TS 3GPP standards such as in, for example, 3GPP TS 38.213) for the NR Serving Cell and the P_{CMAX,c} or \tilde{P}_{CMAX,c} (as specified in 3GPP standards such as in, for example, 3GPP TS 36.213) for the E-UTRA Serving Cell used for calculation of the preceding PH field. The reported P_{CMAX,ƒ,c} and the corresponding nominal wireless device transmit power levels are shown in Table 3 (the corresponding measured values in dBm for the NR Serving Cell are specified in 3GPP standards such as in, for example, 3GPP TS 38.133 while the corresponding measured values in dBm for the E-UTRA Serving Cell are specified in 3GPP standards such as in, for example, 3GPP TS 36.133);
MPE: If mpe-Reporting-FR2 is configured, and the Serving Cell operates on FR2, and if the P field is set to 1, this field indicates the applied power backoff to meet MPE requirements, as specified in 3GPP standards such as in, for example, 3GPP TS 38.101-2. This field indicates an index to Table 4 and the corresponding measured values of P-MPR levels in dB are specified in 3GPP standards such as in, for example, 3GPP TS 38.133. The length of the field is 2 bits. If mpe-Reporting-FR2 is not configured, or if the Serving Cell operates on FR1, or if the P field is set to 0, R bits are present instead.
D-PC: If powerClassFallBackReporting is configured, and the Serving Cell operates on FR1, this field indicates the applied power class-fallback, as specified in 3GPP standards such as in, for example, 3GPP TS 38.101-1. This field indicates an index to Table 5 and the corresponding power-class fallback levels in dB are specified in 3GPP standards such as in, for example, 3GPP TS 38.133. The length of the field is 2 bits. If powerClassFallBackReporting is not configured, or if the Serving Cell operates on FR2, R bits are present instead

FIG. 15 is a diagram of a Multiple Entry PHR MAC CE with the highest ServCellIndex of Serving Cell with configured uplink is less than 8. “MPE or R” may be replaced with “MPE, D-PC or R” and the “R-bit” in the first octet may be replaced with “D-PC-bc or R.”

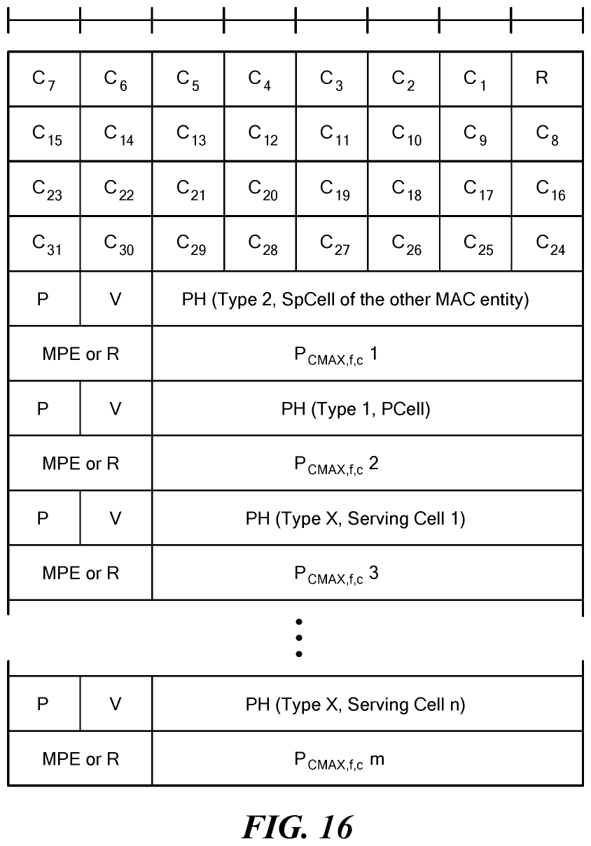

FIG. 16 is a diagram of a Multiple Entry PHR MAC CE with the highest ServCellIndex of Serving Cell with configured uplink is equal to or higher than 8. “MPE or R” may be replaced with “MPE, D-PC or R” throughout and the “R-bit” in the first octet may be replaced with “D-PC-bc or R.”

### <End of Change>

The above changes are shown for fallback reporting in FR1 but the method can be applied within each device-class in FR2 (Frequency Range 2 described in clause 5 in 3GPP TS 38.101-1 v17.6.0 2022-06).

### SOME EXAMPLES

Example 1. A method for triggering Power Headroom Reporting procedure, at a wireless device 22 capable of communicating to the network node 16 with more than one power class, where the wireless device 22 is operated in one or more than one serving cells, the method including:
Configuring a first timer;
Determining whether the wireless device has a UL resource for new transmission; and
When the wireless device has a UL resource for new transmission, the method further comprising:
   Triggering a power headroom report when the first timer expires or has expired and at least one of a plurality of power class values has changed more than a PowerClassChange threshold since the last transmission of a previous power headroom report, where the power class values correspond to one of the following:
      At least one activated serving cell
      A configured band combination with at least one activated serving cell; and
   Reporting the power headroom report

Example 2. A method according to Example 1, wherein the reporting the power headroom report further includes:
Reporting the power head room report by media access control-control element, MAC CE, where the media access control-control element includes:
   At least one power headroom field, where the at least one power headroom field indicates one or more power class change value(s) of the corresponding one of the following:
      activated serving cell
      configured band combination with at least one activated serving cell;

Example 3. A method according to Example 1, wherein the first timer includes one of the following:
prohibitPHR-Timer
mpe-ProhibitTimer
a second timer for power class change
a third timer which takes into account the one or more than more of the above timers.

Example 4. A method according to Example 1, further including reporting the power headroom report periodically or aperiodically.

Example 5. A method according to Example 2, wherein the one or more power class change value(s) of the corresponding configured band combination with at least one activated serving cell further comprises the following:
the one or more power class change values are corresponding to the one or more activated serving cells in the configured band combination.

Hence, in one or more embodiments, the network node 16 configures power-class fallback reporting when configuring PHR for a cell group of one of more serving cells. The power-class fallback configuration includes the power-class change (in dB) at which the PHR is configured for a serving cell.

A PHR is triggered whenever the wireless device 22 is changing the power class by ΔP_{powerclass} for a serving cell or ΔP_{powerclass,CA} for a band combination (power-class fallback) in the configured maximum output power for the wireless device 22.

Spare bits in the single-entry and multiple-entry PHR inform the network node 16 that the PHR is triggered by a power-class change (this is not in conflict with the bits used for MPE reporting optionally configured for FR2 cells. The present disclosure may be relevant for FR1, as power-class fallback does not exist yet in FR2, but may be applied to FR2 in the future.

Hence, one or more embodiments provide one or more following advantages. By the PHR trigger event, the network node 16 is aware of the time instant at which the wireless device 22 applies a modification ΔP_{powerclass} for a serving cell or ΔP_{powerclass,CA} for a band combination, such that the power reported to (and assumed by) a network node 16 and the actual power available from the wireless device 22 are aligned. This allows for the power usage to be more optimized for both the wireless device 22 and the network node 16, from a system point of view.

By an explicit indication in the PHR of the ΔP_{powerclass} and ΔP_{powerclass,CA}, the network node 16 is aware that changes in the PH for the serving cells are due to power-class fallback. So, such information can be used from at network node 16 to further optimize the resource allocation for the wireless device 22 and/or to perform another function/action to optimize performance at the wireless device 22.

Some embodiments may include one or more of the following:

Embodiment A1. A network node configured to communicate with a wireless device, the network node configured to, and/or comprising a radio interface and/or comprising processing circuitry configured to:
receive a power headroom report including an indication of a power capability modification, at the wireless device, from a first power capability to a second power capability among a plurality of power capabilities; and
perform at least one action based on the power headroom report.

Embodiment A2. The network node of Embodiment A1, wherein the power capability modification corresponds to an actual power available at the wireless device.

Embodiment A3. The network node of any one of Embodiments A1-A2, wherein the power headroom report includes at least one preconfigured reserved bit, the indication being provided in the at least one preconfigured reserved bit.

Embodiment A4. The network node of any one of Embodiments A1-A3, wherein the indication is configured to distinguish a power headroom report trigger event from other events that trigger the power headroom report.

Embodiment A5. The network node of any one of Embodiments A1-A4, wherein the power capability modification corresponds to one of:
a ΔP_{powerclass} for a serving cell; and
a ΔP_{powerclass,CA} for a band combination.

Embodiment B1. A method implemented in a network node that is configured to communicate with a wireless device, the method comprising:
receiving a power headroom report including an indication of a power capability modification, at the wireless device, from a first power capability to a second power capability among a plurality of power capabilities; and performing at least one action based on the power headroom report

Embodiment B2. The method of Embodiment B1, wherein the power capability modification corresponds to an actual power available at the wireless device.

Embodiment B3. The method of any one of Embodiments B1-B2, wherein the power headroom report includes at least one preconfigured reserved bit, the indication being provided in the at least one preconfigured reserved bit.

Embodiment B4. The method of any one of Embodiments B1-B3, wherein the indication is configured to distinguish a power headroom report trigger event from other events that trigger the power headroom report.

Embodiment B5. The method of any one of Embodiments B1-B4, wherein the power capability modification corresponds to one of:
a ΔP_{powerclass} for a serving cell; and
a ΔP_{powerclass,CA} for a band combination.

Embodiment C1. A wireless device configured to communicate with a network node, the wireless device configured to, and/or comprising a radio interface and/or processing circuitry configured to:
determine a power capability modification from a first power capability to a second power capability among a plurality of power capabilities; and
cause transmission of a power headroom report including the indication of the power capability modification.

Embodiment C2. The wireless device of Embodiment C1, wherein the power capability modification corresponds to an actual power available at the wireless device.

Embodiment C3. The wireless device of any one of Embodiments C1-C2, wherein the power headroom report includes at least one preconfigured reserved bit, the indication being provided in the at least one preconfigured reserved bit.

Embodiment C4. The wireless device of any one of Embodiments C₁-C₃, wherein the indication is configured to distinguish a power headroom report trigger event from other events that trigger the power headroom report.

Embodiment C5. The wireless device of any one of Embodiments C₁-C₄, wherein the power capability modification corresponds to one of:
a ΔP_{powerclass} for a serving cell; and
a ΔP_{powerclass,CA} for a band combination.

Embodiment D1. A method implemented in a wireless device that is configured to communicate with a network node, the method comprising:
determining a power capability modification from a first power capability to a second power capability among a plurality of power capabilities; and
causing transmission of a power headroom report including the indication of the power capability modification.

Embodiment D2. The method of Embodiment D1, wherein the power capability modification corresponds to an actual power available at the wireless device.

Embodiment D3. The method of any one of Embodiments D1-D2, wherein the power headroom report includes at least one preconfigured reserved bit, the indication being provided in the at least one preconfigured reserved bit.

Embodiment D4. The method of any one of Embodiments D1-D3, wherein the indication is configured to distinguish a power headroom report trigger event from other events that trigger the power headroom report.

Embodiment D5. The method of any one of Embodiments D1-D4, wherein the power capability modification corresponds to one of:
a ΔP_{powerclass} for a serving cell; and
a ΔP_{powerclass,CA} for a band combination.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| CE | Control Element |
| EN-DC | E-UTRA NR Dual Connectivity with E-UTRA |
| | connected to EPC |
| MAC | Media Access Control |
| MPR | Maximum Power Reduction |
| MPE P-MPR | the power backoff to meet the MPE FR2 |
| | requirements for a Serving Cell operating |
| | on FR2 |
| MR-DC | Multi-Radio Dual Connectivity |
| PHR | Power Headroom Reporting |
| RRC | Radio Resource Control |
| SRS | Sounding Reference Signal |
| UE | User Equipment |
| UL | Uplink |
| WD | Wireless Device |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with a network node, the wireless device configured to:
receive, from the network node, a configuration for power class change reporting;
trigger a first power headroom report, PHR, when a timer for power class change has expired and a power class value has changed more than a threshold since the last transmission of a previous PHR, the first PHR comprising at least one power class change value; and
transmit the first PHR.

2. The WD of claim 1, wherein the at least one power class change value corresponds to at least one of an activated serving cell and a configured band combination with at least one activated serving cell.

3. The WD of claim 2, wherein the first PHR indicates a power class change value of at least one of the activated serving cell and the configured band combination.

4. The WD of claim 3, wherein:
two reserved bits are used to indicate the power class change value for the activated serving cell, and
one reserved bit is used to indicate the power class change value for the configured band combination.

5. The WD of claim 4, wherein:
when two reserved bits are used to indicate the power class change value for the activated serving cell, the indicated power class change value being at least one of 0, 3, and 6 dB, and
when one reserved bit is used to indicate the power class change value for the configured band combination, the indicated power class change value being one of 0 dB or a value configured by higher layer signaling.

6. The WD of claim 5, wherein, when the indicated power class change value is a value configured by higher layer signaling, the indicated power class change value being equivalent to a threshold.

7. The WD of claim 1, wherein the first PHR is transmitted in a medium access control, MAC, entity for at least one activated serving cell of the MAC entity for which an active uplink bandwidth part, UL BWP, has not been dormant since a second PHR previous to the first PHR was transmitted in the MAC entity when the WD has uplink resources for transmitting the first PHR.

8. The WD of claim 1, wherein the PHR is transmitted in a medium access control, MAC, entity for a configured band combination with at least one activated serving cell of the MAC entity for which active uplink bandwidth parts, UL BWPs, have not been dormant since the a second PHR previous to the first PHR was reported in the MAC entity when the WD has uplink resources for transmitting the first PHR.

9.-11. (canceled)

12. The WD of claim 1, wherein the timer for power class change has a minimum duration between power headroom reports.

13. The WD of claim 1, wherein the first PHR includes reserved bits to enable the network node to distinguish the first PHR from another PHR triggered by other events or a periodic PHR.

14. (canceled)

15. A method in a wireless device, WD, configured to communicate with a network node, the method comprising:
receiving, from the network node, a configuration for power class change reporting;
triggering a first power headroom report, PHR, when a timer for power class change has expired and a power class value has changed more than a threshold since the last transmission of a previous PHR, the first PHR comprising at least one power class change value; and
transmitting the first PHR.

16. The method of claim 15, wherein the at least one power class change value corresponds to at least one of an activated serving cell and a configured band combination with at least one activated serving cell.

17. The method of claim 16, wherein the first PHR indicates a power class change value of at least one of the activated serving cell and the configured band combination.

18. The method of claim 17, wherein:
two reserved bits are used to indicate the power class change value for the activated serving cell, and
one reserved bit is used to indicate the power class change value for the configured band combination.

19. The method of claim 18, wherein:
when two reserved bits are used to indicate the power class change value for the activated serving cell, the indicated power class change value being at least one of 0, 3, and 6 dB, and
when one reserved bit is used to indicate the power class change value for the configured band combination, the indicated power class change value being one of 0 dB or a value configured by higher layer signaling.

20. The method of claim 19, wherein, when the indicated power class change value is a value configured by higher layer signaling, the indicated power class change value being equivalent to a threshold.

21. The method of claim 15, wherein the first PHR is transmitted in a medium access control, MAC, entity for at least one activated serving cell of the MAC entity for which an active uplink bandwidth part, UL BWP, has not been dormant since a second PHR previous to the first PHR was transmitted in the MAC entity when the WD has uplink resources for transmitting the first PHR.

22. The method of claim 15, wherein the first PHR is transmitted in a medium access control, MAC, entity for a configured band combination with at least one activated serving cell of the MAC entity for which active uplink bandwidth parts, UL BWPs, have not been dormant since a second PHR previous to the first PHR was reported in the MAC entity when the WD has uplink resources for transmitting the first PHR.

23.-25. (canceled)

26. The method of claim 15, wherein the timer for power class change has a minimum duration between power headroom reports.

27. The method of claim 15, wherein the first PHR includes reserved bits to enable the network node to distinguish the first PHR from another PHR triggered by other events or a periodic PHR.

28. (canceled)
